(19) United States
(12) Patent Application Publication
(10) Pub. No.: US 2026/0227981 A1
(43) Pub. Date: Aug. 6, 2026

(54) SYSTEMS AND METHODS FOR AN AUTOMATED PLATFORM FOR THE INTEGRATION OF EYE-TRACKING ASSESSMENT MODELS

(71) Applicant: RightEye, LLC, Bethesda, MD (US)

(72) Inventors: Melissa HUNFALVAY, Bethesda, MD (US); Adam Todd GROSS, Bethesda, MD (US); Takumi BOLTE, Mooresville, NC (US)

(73) Assignee: RightEye, LLC, Bethesda, MD (US)

(21) Appl. No.: 19/460,672

(22) Filed: Jan. 27, 2026

Related U.S. Application Data
(60) Provisional application No. 63/752,982, filed on Feb. 3, 2025.

(51) Int. Cl. G06F 8/60; G06F 3/01

(52) U.S. Cl. CPC G06F 8/60; G06F 3/013

(57) ABSTRACT

An exemplary embodiment of a computer-implemented method may include receiving a request from a first sub-system for access to a software development package. The request may include a unique identifier associated with the software development package. The software development package may include an automated conversion engine, a feature repository engine, and an assessment engine. Each engine may be particular to the unique identifier. The method may further include verifying the request using the unique identifier. The method may further include generating a download including the software development package. The method may further include transmitting the download to the first sub-system.

### TECHNICAL FIELD

Various embodiments of this disclosure relate generally to machine-learning and artificial intelligence-based techniques for an automated platform, and, more particularly, to systems and methods for an automated platform for the integration of eye-tracking assessment models.

### BACKGROUND

Software programs very often rely on or are affected by the components of a hardware device and/or firmware on which the software program is run. For example, particularities of hardware and/or firmware may impact the execution of the software operations or the running of a model, such as a machine-learning and/or artificial intelligence model. In many cases, the hardware device, firmware, and related components may be varied, and may be less compatible or incompatible with the software program or model, or may lack particular datasets needed to run such software programs or models, especially if the software program or model was developed on or designed for different hardware and/or firmware. The integration of such software programs or models across varied hardware devices may therefore be difficult.

Unless otherwise indicated herein, the materials described in this section are not prior art to the claims in this application and are not admitted to be prior art, or suggestions of the prior art, by inclusion in this section.

### SUMMARY OF THE DISCLOSURE

In one aspect, an exemplary embodiment of a computer-implemented method may include receiving a request from a first sub-system for access to a software development package. The request may include a unique identifier associated with the software development package. The software development package may include an automated conversion engine, a feature repository engine, and an assessment engine. Each engine may be particular to the unique identifier. The method may further include verifying the request using the unique identifier. The method may further include generating a download including the software development package. The method may further include transmitting the download to the first sub-system.

In another aspect, an exemplary embodiment of a system for integrating one or more assessment models using an automated platform may include a data storage device storing instructions and one or more processors configured to execute the instructions to perform operations. The operations may include receiving a request from a first sub-system for access to a software development package. The request may include a unique identifier associated with the software development package. The software development package may include an automated conversion engine, a feature repository engine, and an assessment engine. Each engine may be particular to the unique identifier. The operations may further include verifying the request using the unique identifier. The operations may further include generating a download including the software development package. The operations may further include transmitting the download to the first sub-system.

In another aspect, an exemplary embodiment of a non-transitory machine-readable medium may store instructions that, when executed by one or more processors, cause the one or more processors to perform a method for integrating one or more assessment models using an automated platform. The method may include receiving a request from a first sub-system for access to a software development package. The request may include a unique identifier associated with the software development package. The software development package may include an automated conversion engine, a feature repository engine, and an assessment engine. Each engine may be particular to the unique identifier. The method may further include verifying the request using the unique identifier. The method may further include generating a download including the software development package. The method may further include transmitting the download to the first sub-system.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for an automated platform for the integration of eye-tracking assessment models, according to one or more embodiments.

FIG. 2 depicts an exemplary process diagram for integrating eye-tracking assessment models, according to one or more embodiments.

FIG. 3 depicts a flowchart of an exemplary method for integrating one or more assessment models using an automated platform, according to one or more embodiments.

FIG. 4 depicts a flow diagram for training a machine-learning model, according to one or more embodiments.

FIG. 5 depicts an example of a computing device, according to one or more embodiments.

FIGS. 6A-6D depict examples of user edge devices, according to one or more embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to an automated platform for the integration of eye-tracking assessment models. Various aspects are directed to an automated deployment process that may include integration of assessment models (e.g., an eye-tracking assessment model) into one or more edge devices via one or more sub-systems. The user device may be added to an existing hardware catalogue to specify the user device when using the software development kit. Further, any unique user device may be capable of running the assessment models subsequent to the model being calibrated for that device by accessing an automated conversion engine, a feature repository engine, and an assessment engine by one or more components of the unique user device. Further, various aspects of the present disclosure may utilize and/or train one or more machine-learning models and/or artificial intelligence models to automate the integration of the eye-tracking assessment models. Additionally, one or more of the assessment models may be trained machine-learning and/or artificial intelligence models.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any combination of supervised or unsupervised techniques or ensemble techniques may also be used. Any suitable type of training may be used, e.g., stochastic, gradient boosted, random seeded, recursive, epoch or batch-based, etc.

In an exemplary embodiment, the automated platform for the integration of eye-tracking assessment models may be deployed in a virtual reality gaming environment. For example, a virtual reality headset manufacturer may access the software development package to calibrate eye-tracking assessment models for their particular headset hardware. The calibrated assessment models may then be used to monitor user conditions such as cognitive load or fatigue during extended gaming sessions, and the gaming application may adjust difficulty levels, suggest breaks, modify visual elements or take another suitable action based on the assessment results.

In another exemplary embodiment, the automated platform may be utilized in an automotive safety context. For example, an automobile manufacturer may integrate the eye-tracking assessment models into vehicle dashboard systems or driver monitoring cameras. The calibrated models may assess conditions such as driver fatigue, stress levels, or attention states while operating the vehicle. Based on the target assessment results, the vehicle system may take any suitable action such as provide alerts to the driver, suggest rest stops, or in some implementations, communicate with advanced driver assistance systems to enhance safety measures.

In another exemplary embodiment, the automated platform may be applied in a telehealth or remote assessment setting. For example, a healthcare provider or research institution may access the software development package to deploy eye-tracking assessment models across various consumer devices such as webcams or mobile phones. The calibrated models may enable remote cognitive assessments, screening for neurological conditions, or monitoring of patient progress over time without requiring specialized clinical equipment, thereby expanding access to eye-tracking based evaluations.

While several of the examples herein involve certain types of machine-learning, it should be understood that techniques according to this disclosure may be adapted to any suitable type of machine-learning. Further, while some embodiments and/or examples pertain or refer to machine-learning, it should be understood that any suitable artificial intelligence technique may be used. It should also be understood that the examples above are illustrative only. The techniques and technologies of this disclosure may be adapted to any suitable activity.

Further, while eye-tracking and various aspects relating to eye-tracking and target assessment results related to eye-tracking features are described in the present aspects as illustrative examples, the present aspects are not limited to such examples. For example, the present aspects can be implemented for other types of feature tracking, such as facial recognition, body and/or kinesthetic movements (e.g., head movements), movements of objects (e.g., cars, planes, and the like), or in any other aspects where tracking features, movement, or progression may be measured and/or assessed. Further, the present systems and methods may be applied to methods and systems of automatically calibrating hardware and/or firmware systems (e.g., of user devices) for a software program or model. A software program (e.g., computer-readable instructions) and/or model (e.g., machine-learning model, artificial intelligence model, assessment model, or the like) may therefore become tuned, calibrated, or configured to any particular user device, regardless of operating system, hardware components, version, firmware, model (e.g., model version), and the like.

In an embodiment, the automated platform may be applied in a sports performance analysis context. For example, a sports equipment manufacturer or athletic training facility may access the software development package to deploy body movement assessment models across various wearable sensors or motion capture devices. The calibrated models may analyze athlete biomechanics, detect fatigue patterns during training sessions, or identify movement inefficiencies that may indicate injury risk. Based on the target assessment results, coaching systems may take any suitable action such as provide real-time feedback to athletes, recommend technique adjustments, or suggest recovery periods to optimize performance and reduce the likelihood of overtraining.

In another embodiment, the automated platform may be utilized in an industrial safety and/or quality control setting. For example, a manufacturing equipment provider may integrate gesture and movement assessment models into factory floor monitoring systems or robotic assembly line cameras. The calibrated models may, for example, assess worker fatigue levels based on hand movements, detect deviations in assembly procedures, monitor the positioning and movement of components during production, etc. Based on the target assessment results, the manufacturing system may take any suitable action such as alert supervisors to potential safety concerns, flag quality control issues for review, or in some implementations, adjust automated equipment parameters to maintain production standards.

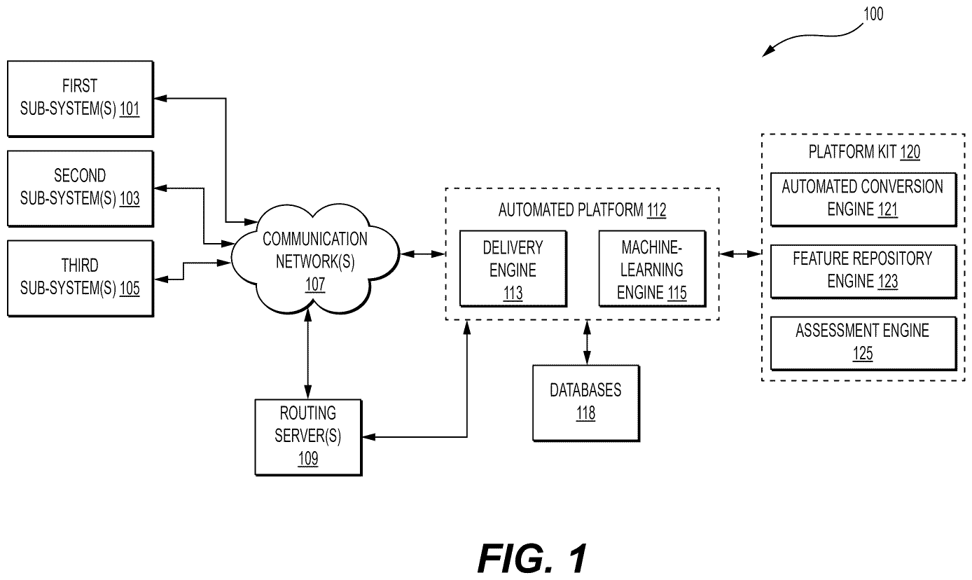

FIG. 1 depicts an exemplary environment 100 for an automated platform for the integration of eye-tracking assessment models. As depicted, environment 100 may include a first sub-system 101, a second sub-system 103, and a third sub-system 105. In various implementations the first, second, and third sub-systems may be associated with a first, second, and third service provider (e.g., a provider of virtual reality headsets, an automobile or accessory device manufacturer, or a computing device manufacturer, or the like).

In one embodiment, sub-system(s) 101, 103, 105 may include any type of mobile terminal, wireless terminal, fixed terminal, or portable terminal utilized by edge device providers, or cloud-based service providers, to communicate with the other system(s) within the environment 100. For example, the first sub-system 101 may include, but is not restricted to, a mobile handset, a wireless communication device, a station, a unit, a device, a multimedia computer (e.g., computer system 500), an Internet node, a communicator, a dashboard computer, a data server, or any combination thereof, including the accessories and peripherals of these devices, or any combination thereof. The first sub-system 101 may facilitate various input devices/functions/mechanisms/systems (e.g., a touch screen capability, a keyboard and keypad data entry, a voice-based input mechanism, etc.) and output devices/functions/mechanisms/systems (e.g., generating, sharing, and viewing of visual content) for hosting an edge device provider's system.

As depicted in FIG. 1, environment 100 may also include a communication network 107 and a routing server 109. In various implementations, the first, second, and third sub-systems may access an automated platform 112 over the communication network 107 and via the routing server 109. As depicted, automated platform 112 may include delivery engine 113 and machine-learning engine 115 (e.g., implementing one or more machine-learning and/or artificial intelligence models), as will be described in further detail below. Automated platform 112 may be configured to deliver and/or integrate (e.g., via delivery engine 113) one or more software development packages, one or more machine-learning models, and/or one or more engines and/or components of platform kit 120 to a sub-system, as will be described in more detail below.

As discussed, platform kit 120 may include automated conversion engine 121. Automated conversion engine 121 may be configured to input a set of eye-tracking data into a time series, generate the set of eye-tracking data at a sampling rate particular to a given edge device using the time series, and form a calibrated assessment model. In various embodiments, to form the calibrated assessment model, the automated conversion engine 121 may receive raw eye-tracking data captured by a user edge device and transform this data into a standardized time series format. The time series may represent sequential measurements of eye-tracking features over a defined temporal window. The automated conversion engine 121 may then resample, interpolate, or otherwise adjust the set of eye-tracking data to match a sampling rate that corresponds to the specifications of the given edge device. Different edge devices may capture eye-tracking data at varying sampling rates depending on their hardware capabilities, sensor configurations, or firmware versions. The automated conversion engine 121 may account for these differences by normalizing the data to a consistent format that facilitates accurate processing by the assessment models. In some aspects, the automated conversion engine 121 may apply one or more signal processing techniques, such as filtering, smoothing, or noise reduction, to the eye-tracking data during the conversion process. The automated conversion engine 121 may utilize the processed time series data to form a calibrated assessment model that is configured to operate on the particular edge device (e.g., user device). Further, the calibrated assessment model may be adapted to account for device-specific characteristics, such as display resolution, refresh rate, eye-tracking sensor precision, or latency parameters. In some cases, the automated conversion engine 121 may store configuration parameters or calibration coefficients that define how the assessment model should interpret data from the specific edge device.

The automated conversion engine 121 may be accessed via the automated platform 112, and may be downloaded to a sub-system (e.g., downloaded to first sub-system 101 over network 107 and via routing server 109), may be loaded onto a user edge device, may be stored on a user edge device, or the like. The automated conversion engine 121 may include computer-readable instructions configured to be executed on a sub-system or user edge device (e.g., as a configuration file, using an Application Programming Interface (API), or the like). In various embodiments, the automated conversion engine 121 may be packaged as a software library, a standalone executable, or a set of modular components that may be selectively deployed based on the requirements of the sub-system or user edge device. For example, a virtual reality headset manufacturer may download the automated conversion engine 121 as a dynamic link library that integrates with the headset's native software development environment. In another example, an automobile manufacturer may receive the automated conversion engine 121 as a firmware module that may be flashed onto an embedded processor within a driver monitoring system. The automated conversion engine 121 may expose one or more APIs that allow the sub-system or user edge device to perform operations such as invoke conversion functions, retrieve calibration parameters, or query the status of the conversion process. In some aspects, the automated conversion engine 121 may operate in a background process on the user edge device, continuously processing incoming eye-tracking data streams and outputting calibrated data to the assessment engine. In some aspects, the automated conversion engine 121 may be invoked on demand when a particular assessment is requested. The automated conversion engine 121 may include versioning information that allows the sub-system to verify compatibility with other components of the platform kit 120 or with specific firmware versions of the user edge device. In some cases, the automated conversion engine 121 may be configured to receive updates or patches from the automated platform 112, allowing the conversion algorithms to be refined or extended without requiring a complete reinstallation of the software development package.

As depicted in FIG. 1, platform kit 120 may also include feature repository engine 123. Feature repository engine 123 may include captured and/or generated eye-tracking data (e.g., eye-tracking features) for use in one or more machine-learning assessment models (e.g., of assessment engine 125). In various embodiments, assessment engine 125 may be formed using output from one or more components and/or models described herein. In examples, assessment engine 125 may be formed using the output of an assessment machine-learning and/or artificial intelligence model (e.g., a target assessment result from a first assessment model, a calibrated assessment model, a low-medium-high assessment model, and the like). In various embodiments, assessment engine 125 may include one or more eye-tracking assessments formed using eye-tracking features of feature repository engine 123.

In some aspects, the assessment engine 125 may receive output from multiple assessment models and aggregate or combine these outputs to generate a composite assessment result. For example, the assessment engine 125 may receive a cognitive load score from a first assessment model, a fatigue level indicator from a second assessment model, and an attention state classification from a third assessment model, and may then synthesize these individual outputs into a unified assessment profile for a user. In some cases, the assessment engine 125 may weigh the outputs from different assessment models based on confidence scores, relevance to a particular use case, or device-specific accuracy metrics.

In various embodiments, the assessment engine 125 may include assessment models configured to output categorical classifications, numerical scores, probability distributions, or temporal patterns. For example, a low-medium-high assessment model may classify a user's cognitive state into one of three discrete categories based on eye-tracking features such as pupil dilation, fixation duration, or saccade velocity. In another example, an assessment model may output a continuous score ranging from zero to one hundred that represents a user's estimated fatigue level. In yet another example, an assessment model may output a probability distribution indicating the likelihood that a user is experiencing each of one or more possible cognitive states, such as focused attention, divided attention, or mind wandering.

The assessment engine 125 may also include assessment models that have been trained for specific application domains or user populations. For example, the assessment engine 125 may include an assessment model trained specifically for detecting driver drowsiness using eye-tracking features captured in automotive environments, as well as a separate assessment model trained for assessing cognitive workload in virtual reality gaming contexts. In some implementations, the assessment engine 125 may select which assessment model or combination of models to apply based on metadata associated with the incoming eye-tracking data, such as the device type, application context, or user profile.

In various embodiments, the eye-tracking assessments formed by the assessment engine 125 may utilize eye-tracking data stored in feature repository engine 123 as reference data, baseline measurements, or normalization parameters. For example, assessment engine 125 may compare a user's current eye-tracking features against population-level distributions stored in feature repository engine 123 to determine whether the user's measurements fall within typical ranges or indicate an anomalous state. In another example, the assessment engine 125 may retrieve device-specific calibration data from the feature repository engine 123 to adjust assessment thresholds or model parameters for a particular user edge device.

In various embodiments, feature repository engine 123 may serve as a centralized storage and management system for eye-tracking data that has been collected from multiple sources, devices, or assessment sessions. The feature repository engine 123 may organize the eye-tracking data according to various categorization schemes, such as by device type, user demographic, assessment type, or temporal characteristics. For example, feature repository engine 123 may maintain separate data collections for eye-tracking features captured from virtual reality headsets, automotive driver monitoring systems, mobile device cameras, or the like. In some aspects, feature repository engine 123 may include metadata associated with each set of eye-tracking data and/or eye-tracking features, such as the capture conditions, device specifications, sampling rate, or environmental factors present during data collection. Feature repository engine 123 may provide query interfaces that allow the assessment engine 125 or other components to retrieve specific subsets of eye-tracking data based on defined criteria. In some cases, feature repository engine 123 may include synthetic or augmented eye-tracking data that has been generated through simulation or data augmentation techniques to expand the diversity of training samples available for machine-learning models. For example, feature repository engine 123 may store simulated eye-tracking patterns representing various cognitive states, fatigue levels, or attention conditions that may be used to train or validate assessment models. In another example, feature repository engine 123 may include eye-tracking data that has been transformed through rotation, scaling, or temporal shifting to create additional training variations. Feature repository engine 123 may also maintain version histories of stored data, enabling the system to track changes to the repository over time or to revert to previous data states if needed. In some implementations, feature repository engine 123 may synchronize with the automated platform 112 to receive updated datasets or to contribute newly captured eye-tracking data back to a centralized repository for use by other sub-systems.

In various embodiments, the components, or engines, of platform kit 120 may combine to allow a receiving system (e.g., first sub-system 101) the ability to calibrate one or more assessment models (e.g., included with assessment engine 125) to a user edge device that is particular to that sub-system. In other words, should a user associated with first sub-system 101 desire to calibrate and install one or more assessment models onto a particular user edge device, said user may gain access to platform kit 120 via automated platform 112. Thereafter, platform kit 120 would include all components needed to deploy and calibrate the one or more assessment models for the user edge device (e.g., the assessment engine including the assessment models, the feature repository that informs/trains the assessment models, and the automated conversion engine that calibrates the assessment models to the user edge device).

In various embodiments, the platform kit 120 may be configured to support a range of deployment scenarios depending on the capabilities and requirements of the receiving system. For example, a sub-system associated with a hardware manufacturer may utilize the platform kit 120 to integrate assessment models into devices during the manufacturing process, such that the assessment models are pre-installed and calibrated when the devices are shipped to end users. In another example, a sub-system associated with a software application developer may utilize the platform kit 120 to add assessment capabilities to an existing application through a software update or plugin installation. The platform kit 120 may include documentation, sample code, or integration guides that assist developers in incorporating the various engines into their systems. In some aspects, the platform kit 120 may provide testing utilities or validation tools that allow a sub-system to verify that the assessment models are functioning correctly on a particular user edge device prior to deployment. The platform kit 120 may also include licensing information or usage terms that define how the components may be distributed or incorporated into commercial products. In some cases, the platform kit 120 may be customized or configured based on the unique identifier associated with the requesting sub-system, such that different sub-systems receive platform kits tailored to their specific device types, application domains, or contractual arrangements. For example, a first sub-system associated with an automotive manufacturer may receive a platform kit 120 that includes assessment models optimized for driver monitoring applications, while a second sub-system associated with a healthcare provider may receive a platform kit 120 that includes assessment models configured for clinical cognitive assessments. The modular architecture of the platform kit 120 may allow sub-systems to selectively deploy only the components that are relevant to their use case, thereby reducing storage requirements and simplifying integration efforts on resource-constrained edge devices.

In various embodiments, a system for integrating eye-tracking assessment models may include an automated platform, one or more sub-systems in communication with the automated platform over a communication network, and one or more user edge devices associated with the one or more sub-systems. The automated platform may include a delivery engine configured to transmit software development packages to the one or more sub-systems and a machine-learning engine configured to generate, train, or calibrate one or more assessment models. The one or more sub-systems may include computing devices operated by edge device providers, hardware manufacturers, software application developers, or service providers that access the automated platform to obtain platform kits for deployment on user edge devices. The one or more user edge devices may include devices such as virtual reality headsets, automobile driver monitoring systems, web cameras, mobile phones, or other devices capable of capturing eye-tracking data.

In such a system, the automated conversion engine may be loaded onto or executed by a user edge device associated with a sub-system. The automated conversion engine may receive raw eye-tracking data captured by one or more sensors or input devices of the user edge device. In some aspects, the automated conversion engine may convert the raw eye-tracking data into a time series format representing sequential measurements of eye-tracking features over a defined temporal window. The automated conversion engine may resample, interpolate, or otherwise adjust the eye-tracking data to match a sampling rate that corresponds to the specifications of the user edge device. In various embodiments, the automated conversion engine may apply signal processing techniques, such as filtering, smoothing, or noise reduction, to the eye-tracking data during the conversion process. The automated conversion engine may then utilize the processed time series data to form a calibrated assessment model that is configured to operate on the particular user edge device, accounting for device-specific characteristics such as display resolution, refresh rate, eye-tracking sensor precision, or latency parameters.

In various embodiments, the assessment engine may receive the processed eye-tracking data from the automated conversion engine and apply the calibrated assessment model to the data. The assessment engine may analyze the eye-tracking features to determine a target assessment result, such as a cognitive load level, a fatigue indicator, a stress state, an attention state classification, or other assessments based on the eye-tracking data. In some aspects, the assessment engine may aggregate outputs from multiple assessment models to generate a composite assessment result. The assessment engine may output categorical classifications, numerical scores, probability distributions, or temporal patterns depending on the configuration of the calibrated assessment model.

In some aspects, the user edge device may utilize the target assessment results output by the assessment engine to perform one or more actions. For example, the user edge device may adjust application parameters based on the target assessment result, such as modifying display brightness, adapting content complexity, or changing difficulty levels in a gaming application. In another example, the user edge device may provide notifications or alerts to a user based on the target assessment result, such as suggesting breaks during extended use, recommending rest stops in an automotive context, or providing feedback regarding attention states. In some cases, the user edge device may communicate the target assessment results to other device systems, such as advanced driver assistance systems in an automobile, health monitoring applications on a mobile device, or remote assessment platforms for telehealth evaluations. The system may therefore enable the integration and deployment of calibrated assessment models across a diverse ecosystem of user edge devices, allowing each device to capture eye-tracking data, process the data through the automated conversion engine, apply the calibrated assessment model via the assessment engine, and utilize the resulting assessments to enhance user experiences or safety.

As depicted in FIG. 1, environment 118 may also include databases 118. Databases 118 may include a server system and/or a data storage system such as computer-readable memory such as a hard drive, flash drive, disk, etc. In some embodiments, the databases 118 include and/or interact with an API for exchanging data to other systems, e.g., one or more of the other components of the environment 100. The databases 118 may include and/or act as a repository or source for storing eye-tracking data, assessment models, software development kits (e.g., platform kit 120), and the like. In some embodiments, the eye-tracking data, and/or other inputs and/or outputs of any of the components of environment 100 may not be retained/stored beyond the processing of the data.

As discussed in further detail below, the automated platform 112 may one or more of (i) generate, store, train, communicate with, or use a machine-learning model and/or an artificial intelligence model (e.g., generated by machine-learning engine 115) configured to integrate one or more eye-tracking assessment models. As used herein, “machine-learning model” may be used interchangeably with one or more machine-learning and/or artificial intelligence models. Machine-learning engine 115 may therefore include a machine-learning model, an artificial intelligence model, and/or instructions associated with the machine-learning model and/or the artificial intelligence model, e.g., instructions for generating a machine-learning model, training the machine-learning model, using the machine-learning model etc. The automated platform 112 may include instructions for retrieving data, adjusting data, e.g., based on the output of the machine-learning and/or artificial intelligence model, one or more interventions, one or more reports and/or graphical representations of data and/or the target assessment result, or the like, e.g., as adjusted based on the machine-learning and/or artificial intelligence model. The machine-learning engine 115 may include training data, and may include ground truth, e.g., (i) training data, (ii) training results to generate the integration results.

In a particular embodiment, machine-learning engine 115 may be trained to identify associations between features of sub-systems and features of platform kits and output an optimized platform kit for a particular sub-system. For example, machine-learning engine 115 may analyze characteristics of a requesting sub-system, such as the type of edge devices manufactured by the sub-system, the target application domain, the hardware specifications of the devices, input devices or sensors of the edge devices, the operating system or firmware versions supported, or the intended user population, and may correlate these characteristics with features of available platform kit components to determine an optimal configuration. In some aspects, machine-learning engine 115 may learn from historical deployment data to identify which combinations of assessment models, feature repository datasets, and conversion engine configurations have performed well for sub-systems with similar characteristics. For example, if multiple sub-systems associated with virtual reality headset manufacturers have previously deployed platform kits with particular assessment models optimized for low-latency eye-tracking and specific calibration parameters for high-refresh-rate displays, machine-learning engine 115 may recommend a similar configuration for a new sub-system in the same domain. In another example, machine-learning engine 115 may identify that sub-systems targeting healthcare applications tend to benefit from assessment models trained on clinical datasets and feature repositories containing normative data from patient populations, and may therefore prioritize these components when generating a platform kit for a healthcare-related sub-system. Machine-learning engine 115 may also consider constraints specified by the sub-system, such as storage limitations on target edge devices, processing power availability, or regulatory requirements, and may adjust the recommended platform kit accordingly. In some cases, machine-learning engine 115 may generate multiple candidate platform kit configurations and rank them based on predicted performance metrics, compatibility scores, or alignment with the sub-system's stated objectives. The machine-learning engine 115 may also update its associations over time as new sub-systems deploy platform kits and provide feedback regarding the effectiveness of the deployed configurations, thereby continuously refining its recommendations for future requests.

In various embodiments, machine-learning engine 115 may calibrate particular assessment models to particular (e.g., unique) edge devices based on the input devices and/or sensors of the unique edge device. For example, an edge device equipped with a high-resolution infrared eye-tracking sensor may be calibrated to utilize assessment models that rely on detailed pupil dilation measurements and corneal reflection patterns, whereas an edge device equipped with a standard RGB camera may be calibrated to utilize assessment models that derive eye-tracking data and/or features from visible light imagery and facial landmark detection. In some aspects, machine-learning engine 115 may analyze the sensor specifications of an edge device, such as the sensor resolution, frame rate, field of view, or spectral sensitivity, and may select or adjust assessment model parameters to match the data characteristics that the sensor is capable of producing. For example, an edge device with a 120 Hz eye-tracking sensor may be calibrated to utilize assessment models that analyze rapid saccadic movements and microsaccades, while an edge device with a 30 Hz camera may be calibrated to utilize assessment models that focus on longer-duration fixations and gaze patterns that are detectable at lower sampling rates. In another example, an edge device that includes both an eye-tracking sensor and an electroencephalography (EEG) sensor may be calibrated to utilize multi-modal assessment models that combine eye-tracking features with neural activity measurements to generate target assessment results. Machine-learning engine 115 may also account for the positioning and orientation of input devices or sensors on the edge device when calibrating assessment models. For example, a virtual reality headset with eye-tracking sensors positioned at a fixed distance from the user's eyes may require different calibration parameters than a dashboard-mounted camera in an automobile that captures eye-tracking data from a variable distance depending on the driver's seating position. In some cases, machine-learning engine 115 may configure the edge device to preprocess or filter the raw sensor data prior to inputting the data into an assessment model, such as by applying noise reduction algorithms suited to the particular sensor type or by normalizing the data to account for sensor-specific artifacts. The edge devices may collect data through their respective input devices or sensors and transmit this data to the calibrated assessment models, which may then process the data according to the device-specific configurations established by machine-learning engine 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training of one or more machine-learning models (e.g., of machine-learning engine 115) may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations within data such that the trained machine-learning model is configured to output a result.

In various embodiments, the variables of a machine-learning model may be interrelated in any suitable arrangement in order to generate the output. For example, in some embodiments, the machine-learning model may include feature processing architecture that is configured to identify, isolate, and/or extract features in data. For example, the machine-learning model may include one or more convolutional neural network (“CNN”) configured to identify features in the data, and may include further architecture, e.g., a connected layer, neural network, etc., configured to determine a relationship between the identified features in order to determine an accurate result.

In some embodiments, the machine-learning model of the machine-learning engine 115 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account.

Although depicted as separate components in FIG. 1, it should be understood that a component or portion of a component in the environment 100 may, in some embodiments, be integrated with or incorporated into one or more other components. For example, components of environment 100 may be embodied within an executable file (e.g., a configuration file) or a software program that is accessed, downloaded by, or otherwise integrated onto a user system (e.g., first sub-system 101). In another example, the automated platform 112 may be integrated in a data storage system. The data storage system may be configured to communicate and/or receive/send data across network 107 to other components of environment 100. In some embodiments, operations or aspects of one or more of the components discussed above may be distributed amongst one or more other components. In some embodiments, components and/or portions of components of environment 100, as well as operations or aspects of one or more of the components discussed above may be implemented using one or more edge devices. In this way, the data may be processed remotely by the one or more edge devices, by a local server, or the like. Any suitable arrangement and/or integration of the various systems and devices of the environment 100 may be used.

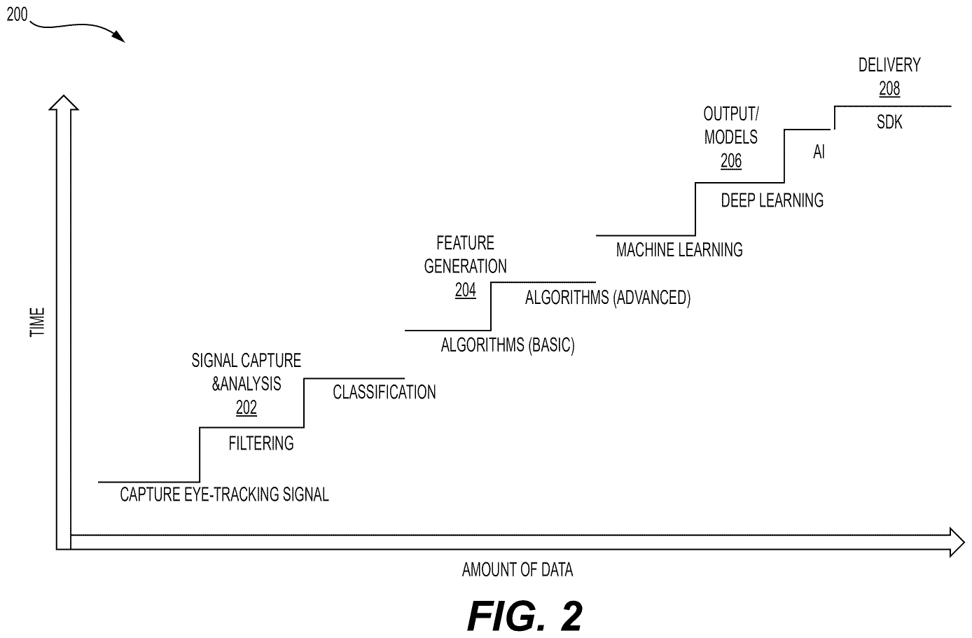

FIG. 2 depicts an exemplary process diagram for integrating eye-tracking assessment models. A process for development and/or integration of eye-tracking models may involve four major phases. A first phase 202 may include creating a classification model. A first step of the first phase 202 may include identifying a target. In examples, this may be the variable or metric that is being predicted. It may also be called the dependent variable or the response variable. In examples, such targets may include cognitive load, or fatigue, or stress. An eye-tracking signal may be captured that informs the target. A second step of the first phase 202 may include determining a validation measure (e.g., by filtering). This may also referred to as the “ground truth” or “gold standard.” It may be a widely accepted measure of the target variable. For example, the NASA-TLX is the validation measure for cognitive load, and the Visual Fatigue Survey (VFS) is the validation measure for fatigue. A third step of the first phase 202 may include applying the data to create a classification. The automated platform (e.g., using machine-learning engine 115, as depicted in FIG. 1) may analyze eye-tracking data to form solutions or outcomes. A fourth step of the first phase 202 may include determining features. Machine-learning methodology may be used to determine which eye tracking features help identify the target state.

In various embodiments, the fourth step of the first phase of Signal Capture and Analysis 202 may involve the application of feature selection and feature importance techniques to identify which eye-tracking data contribute to the identification of the target state. For example, machine-learning engine 115 may analyze a plurality of eye-tracking data, such as fixation duration, fixation count, saccade amplitude, saccade velocity, pupil diameter, blink rate, blink duration, gaze dispersion, smooth pursuit accuracy, or vergence angle, and may determine which subset of these features provides predictive value for the target variable. In some aspects, one or more machine-learning models may employ techniques such as recursive feature elimination, permutation importance, or gradient-based feature attribution to rank the eye-tracking data according to their contribution to the classification outcome. In some cases, the feature determination process may identify that certain eye-tracking data are more informative for particular target states than others. For example, pupil dilation and blink rate may be identified as informative data (e.g., features) for detecting fatigue, while fixation duration and saccade frequency may be identified as informative data for assessing cognitive load. The machine-learning engine 115 may also identify interactions between eye-tracking data that, when considered together, provide greater predictive accuracy than when considered individually. In some implementations, the feature determination process may reduce the dimensionality of the eye-tracking data by selecting a subset of data and/or features that captures the majority of the variance relevant to the target state, which may reduce computational requirements or improve model generalization. The determined data may be used to inform the construction of assessment models in subsequent phases, such that the assessment models are configured to process and analyze the identified eye-tracking data and/or features when generating target assessment results.

A second phase of Feature Generation 204 may include creating a time series model using one or more algorithms. A first step in the second phase 204 may include transferring data to a time series. In various embodiments, the data may then be sequenced into segments to form time-series data. A second step of the second phase 204 may include building a time series model. In examples, machine-learning or artificial intelligence may be used to build a time series model, and may include forecasting, Long Short-Term Memory (LSTM) models, or the like. A third step in the second phase 204 may include tuning the model. Tuning parameters may be used to refine outputs and/or results of the models.

In various embodiments, building the time series model may involve configuring the model architecture to capture temporal dependencies and patterns within the sequenced eye-tracking data. For example, an LSTM model may be constructed with one or more hidden layers, where each layer contains a number of memory cells configured to retain information across time steps. The number of hidden layers, the number of memory cells per layer, and the connections between layers may be selected based on the complexity of the eye-tracking patterns being modeled and the computational resources available on the target edge device. In some aspects, the time series model may incorporate attention mechanisms that allow the model to weigh certain time steps more heavily than others when generating predictions, which may be useful for identifying transient eye-tracking events such as sudden changes in pupil diameter or rapid shifts in gaze direction. In some cases, the time series model may be configured as an encoder-decoder architecture, where an encoder network processes the input sequence of eye-tracking data and generates a compressed representation, and a decoder network uses this representation to produce the target assessment result or to forecast future eye-tracking states. The time series model may also incorporate dropout layers or regularization techniques to reduce overfitting during training, particularly when the available training data is limited. In some implementations, the time series model may be designed to accept variable-length input sequences, allowing the model to process eye-tracking data captured over different durations without requiring padding or truncation. The model may also be configured to output predictions at each time step, providing a continuous stream of assessment results, or to output a single prediction after processing the entire input sequence. In some aspects, multiple time series models may be built in parallel, each configured with different hyperparameters or architectural choices, and the model that achieves the best performance on a validation dataset may be selected for deployment.

A third phase for generating Output Models 206 may include a transfer process. In embodiments, transfer learning may be applied to pre-trained base models, such as those described herein. Transfer learning may be implemented using supervised deep learning that involves transferring knowledge from one task to another. In this way, general features and patterns learned by the pre-trained model and may be adapted to related situations. In examples, the general features and patterns learned by the pre-trained model may be adapted to different hardware or firmware updates (e.g., of user edge devices) and to new environments or stimuli, and the like. In various implementations, the transfer process may also include one or more of: decoupling algorithms from stimuli and testing models using various stimuli, testing using ground truth outcomes in new devices and firmware updates, deep learning with model parameter tuning with new trained layers, blind testing and then unblinding results against ground truth measures, and stress testing models. Further, and to evaluate the success of the transfer process, models may be re-run to determine if results fall within the same parameters as previous results.

A fourth phase for Delivery 208 may include the deployment or integration of an automated conversion engine, such as automated conversion engine 121, as described with respect to FIG. 1. In various embodiments, the automated conversion engine may normalize an eye-tracking data stream to enable processes occurring at subsequent steps in the pipeline to work accurately. In examples, this further transfers the results thereby making the models interoperable.

In various embodiments, the automated conversion engine may receive raw eye-tracking data from a user edge device and apply one or more normalization techniques to standardize the data format, scale, and temporal characteristics. For example, the automated conversion engine may resample the eye-tracking data to a target sampling rate that matches the requirements of the assessment models, interpolating or decimating data points as needed to achieve the desired temporal resolution. In some aspects, the automated conversion engine may apply coordinate transformations to convert eye-tracking measurements from device-specific coordinate systems to a standardized reference frame, which may enable assessment models trained on data from one device type to process data captured by a different device type. The automated conversion engine may normalize numerical ranges of eye-tracking features, such as scaling pupil diameter measurements to a common range or adjusting gaze position coordinates to account for differences in display dimensions across devices. In some cases, the automated conversion engine may detect and correct for device-specific artifacts or biases in the eye-tracking data, such as systematic offsets in gaze position estimates or variations in pupil measurement accuracy under different lighting conditions. The automated conversion engine may apply temporal alignment techniques to synchronize eye-tracking data with other data streams or with external events, such as stimulus presentations or user interactions. In some implementations, the automated conversion engine may segment continuous eye-tracking data streams into discrete windows or epochs that correspond to the input requirements of the assessment models. The normalization and conversion processes performed by the automated conversion engine may enable the assessment models to operate consistently across a variety of user edge devices, hardware configurations, and firmware versions, which may facilitate the interoperability of the models across the diverse ecosystem of devices that may access the automated platform.

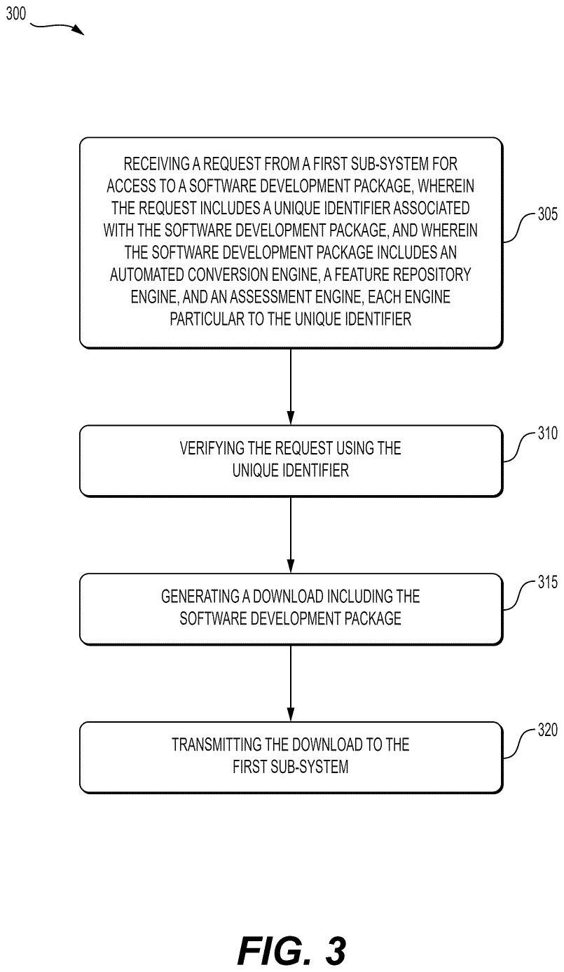

Turning now to FIG. 3, a flowchart of an exemplary method for integrating one or more assessment models using an automated platform is depicted. In the following method described below, various acts may be described as performed or executed by a component from FIG. 1 and/or a phase of FIG. 2. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

At step 305 of exemplary method 300, a request from a first sub-system for access to a software development package may be received (e.g., such as by automated platform 112, as depicted in FIG. 1, from first sub-system 101, or the like). The request may include a unique identifier associated with the software development package. In examples, the unique identifier may be a token associated with the requesting sub-system. The software development package may include an automated conversion engine, a feature repository engine, and an assessment engine, each engine particular to the unique identifier.

At step 310, the request may be verified using the unique identifier. In implementations, the unique identifier (or token) may be used to verify access to the software development kit by associating the unique identifier with one or more permissions defined for a particular sub-system (e.g., first sub-system 101, as depicted in FIG. 1). In examples, the automated platform (e.g., automated platform 112, as depicted in FIG. 1) may assign or provide the unique identifier to the software development kit (e.g., platform kit 120, as depicted in FIG. 1), which unique identifier may then be used to authenticate (e.g., verify) the sub-system against a token held by the automated platform. Once the sub-system's identify and permissions are confirmed, using such verification, they may be authorized to access or download the platform kit's components (e.g., engines) or subsystems.

At step 315, based on verifying the request, a download may be generated that includes the software development package (e.g., the platform kit). As discussed above, the software development package may include an automated conversion engine (e.g., automated conversion engine 121, as depicted in FIG. 1). The automated conversion engine may form a calibrated assessment model specific to a unique user edge device. Therefore, the automated conversion engine may include one or more computer-readable instructions configured to be executed on a unique user edge device, and an assessment model. The first assessment model may have been trained to determine a target assessment result using a set of eye-tracking features data captured at a sampling rate. In examples, the software development package may also include a repository of eye-tracking data (e.g., of feature repository engine 123, as depicted in FIG. 1).

At step 320, the download may be transmitted to the requesting sub-system (e.g., the first sub-system). In various embodiments, the download may be transmitted via a web server (e.g., routing server 109, as depicted in FIG. 1) in electronic communication with the requesting sub-system (e.g., first sub-system 101, as depicted in FIG. 1).

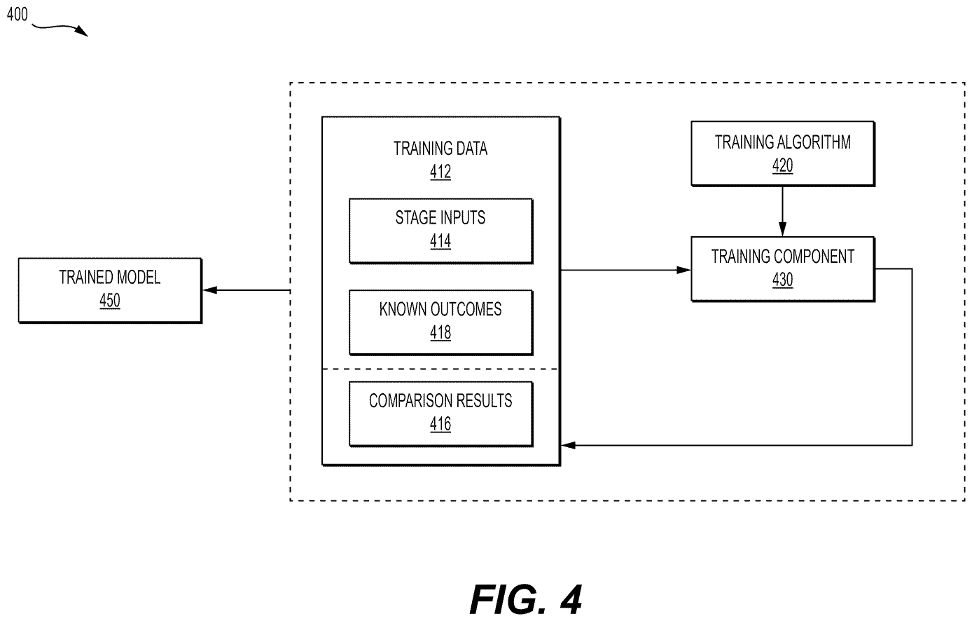

FIG. 4 depicts a flow diagram for training a machine-learning model. As shown in flow diagram 400 of FIG. 4, training data 412 may include one or more of stage inputs 414 and known outcomes 418 related to a machine-learning model to be trained. The stage inputs 414 may be from any applicable source including a component or set shown in the figures provided herein. The known outcomes 418 may be included for machine-learning models generated based on supervised or semi-supervised training. An unsupervised machine-learning model might not be trained using known outcomes 418. Known outcomes 418 may include known or desired outputs for future inputs similar to or in the same category as stage inputs 414 that do not have corresponding known outputs.

The training data 412 and a training algorithm 420 may be provided to a training component 430 that may apply the training data 412 to the training algorithm 420 to generate a trained machine-learning model 450. According to an implementation, the training component 430 may be provided comparison results 416 that compare a previous output of the corresponding machine-learning model to apply the previous result to re-train the machine-learning model. The comparison results 416 may be used by the training component 430 to update the corresponding machine-learning model. The training algorithm 420 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 400 may be a trained machine-learning model 450.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

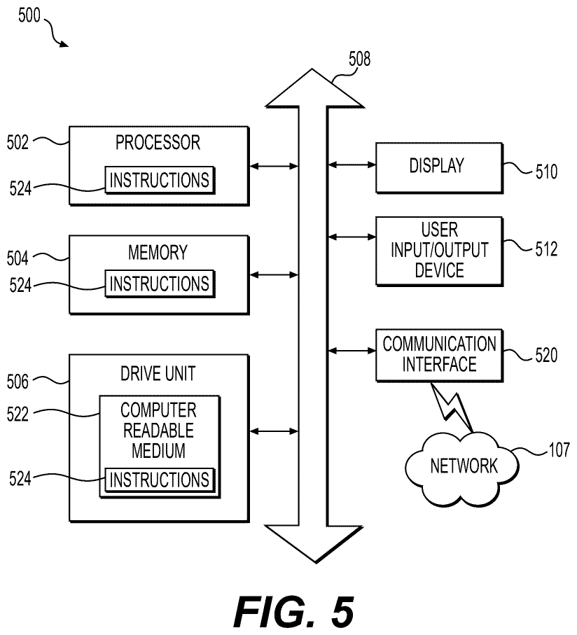

FIG. 5 is a simplified functional block diagram of a computer 500 that may be configured as a device for executing the methods disclosed here, according to exemplary aspects of the present disclosure. For example, the computer 500 may be configured as a system according to exemplary aspects of this disclosure. In various aspects, any of the systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications.

The computer 500 may also have a memory 504 (such as RAM) storing instructions 524 for executing techniques presented herein, for example the systems and methods described with respect to the other Figures, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

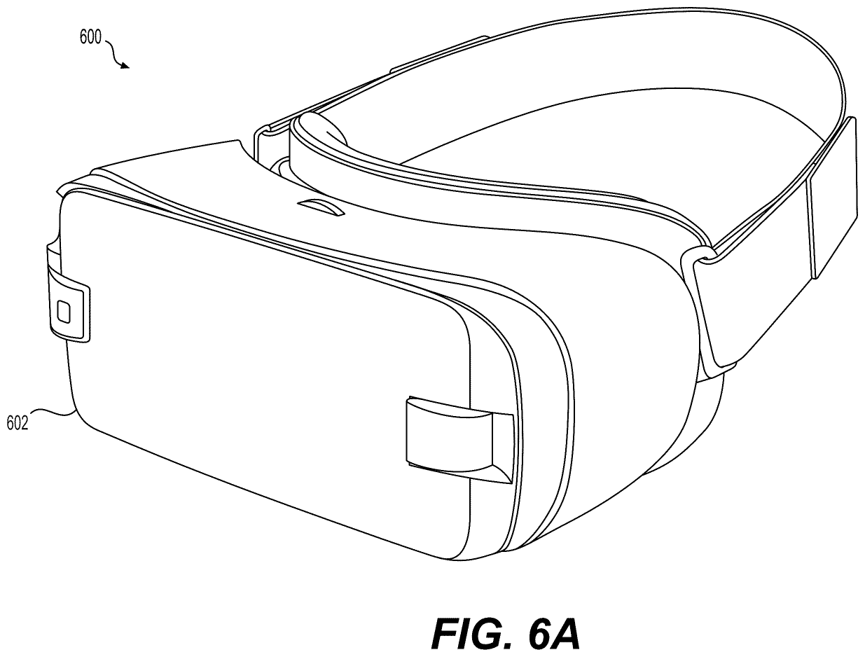

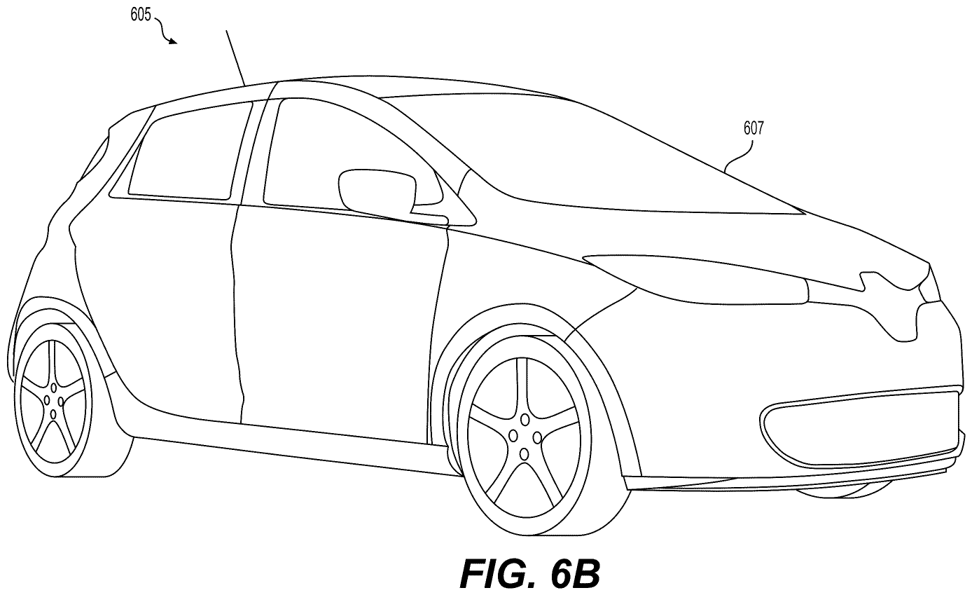

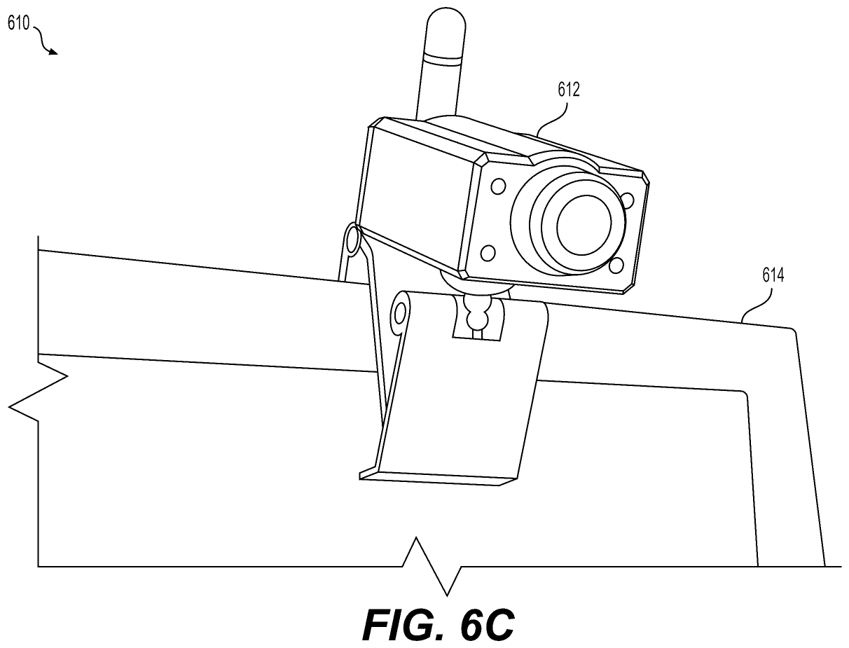

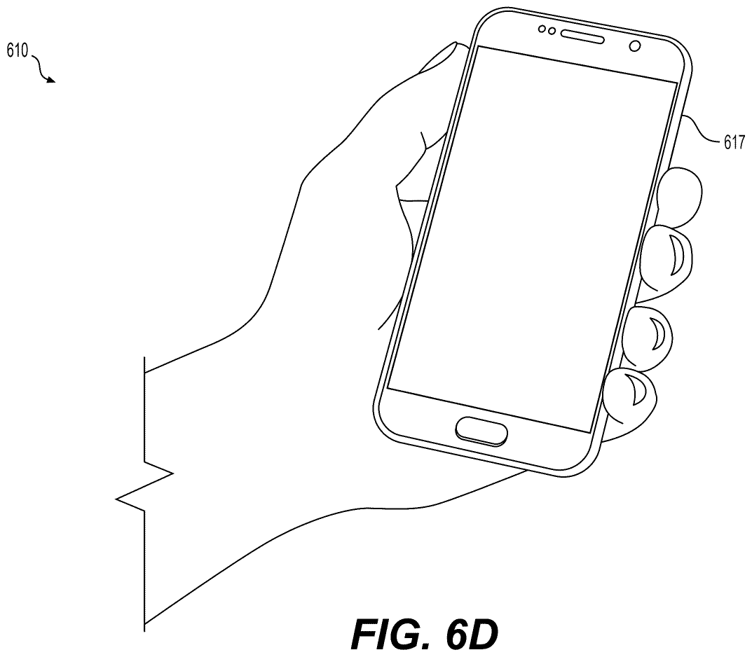

FIG. 6A illustrates an example of a user edge device 600 (e.g., associated with a sub-system). As illustrated, a headset user device 602, such as an AR/VR/XR device, may be calibrated, according to the systems and methods described herein.

In various embodiments, the headset user device 602 may be a virtual reality headset manufactured by a first sub-system that has accessed the software development package from the automated platform. The headset user device 602 may include one or more eye-tracking sensors positioned within the headset housing to capture eye-tracking features data from a user wearing the device. The eye-tracking sensors may capture data such as gaze direction, pupil diameter, fixation duration, saccade patterns, or blink frequency at a sampling rate particular to the hardware specifications of the headset user device 602. In some aspects, the automated conversion engine may be loaded onto the headset user device 602 and may convert the captured eye-tracking data into a time series format suitable for processing by the calibrated assessment model. The calibrated assessment model may then analyze the eye-tracking features to determine a target assessment result, such as a cognitive load level, a fatigue indicator, or an attention state classification. In some cases, the headset user device 602 may utilize the target assessment result to adjust parameters of a virtual reality application, such as modifying display brightness, suggesting a break to the user, or adapting the complexity of rendered content based on the user's assessed cognitive state.

FIG. 6B illustrates another example of a user edge device 605 (e.g., associated with a sub-system). As illustrated, an automobile 607, such as an automobile capable of capturing eye-tracking features data, may be calibrated, according to the systems and methods described herein.

In various embodiments, the automobile 607 may be a vehicle manufactured by a second sub-system that has accessed the software development package from the automated platform. The automobile 607 may include one or more driver monitoring cameras or eye-tracking sensors positioned within the vehicle cabin, such as on the dashboard, steering column, or rearview mirror assembly, to capture eye-tracking features data from a driver operating the vehicle. The eye-tracking sensors may capture data such as gaze direction, eyelid closure duration, pupil diameter variations, fixation patterns on the road or instrument cluster, or head orientation at a sampling rate particular to the hardware specifications of the automobile 607. In some aspects, the automated conversion engine may be integrated into an onboard computing system of the automobile 607 and may convert the captured eye-tracking data into a time series format suitable for processing by the calibrated assessment model. The calibrated assessment model may then analyze the eye-tracking features to determine a target assessment result, such as a driver drowsiness level, a distraction indicator, or a stress state classification. In some cases, the automobile 607 may utilize the target assessment result to trigger driver alerts, such as audible warnings or haptic feedback through the steering wheel, to suggest rest stops via the navigation system, or to communicate with advanced driver assistance systems to adjust vehicle behavior based on the driver's assessed state. In some implementations, the automobile 607 may log the target assessment results over time to generate driver behavior reports or to inform fleet management systems regarding driver wellness patterns.

FIG. 6C illustrates another example of a user edge device 610 (e.g., associated with a sub-system). As illustrated, a web camera 612 (e.g., webcam), such as a web camera 612 capable of capturing eye-tracking features data may be calibrated, according to the systems and methods described herein.

In various embodiments, the web camera 612 may be a consumer-grade or professional-grade camera manufactured by a third sub-system that has accessed the software development package from the automated platform. The web camera 612 may be connected to a computing device, such as a desktop computer, laptop, or tablet, and may capture eye-tracking features data from a user positioned in front of the camera during video conferencing, remote assessments, or other screen-based activities. The web camera 612 may capture data such as gaze position relative to the display, pupil diameter changes, blink patterns, fixation durations on different regions of the screen, or head pose at a sampling rate particular to the hardware specifications of the web camera 612. In some aspects, the automated conversion engine may be installed on the computing device to which the web camera 612 is connected and may convert the captured eye-tracking data into a time series format suitable for processing by the calibrated assessment model. The calibrated assessment model may then analyze the eye-tracking features to determine a target assessment result, such as an engagement level during a video call, a fatigue indicator during extended screen use, or an attention state classification during a remote cognitive assessment. In some cases, the computing device may utilize the target assessment result to provide feedback to the user, such as suggesting screen breaks, adjusting display settings to reduce eye strain, or generating reports for healthcare providers conducting telehealth evaluations. In some implementations, the web camera 612 may be deployed in educational settings to monitor student attention during remote learning sessions or in workplace environments to assess employee focus during virtual meetings.

FIG. 6D illustrates another example of a user edge device 615 (e.g., associated with a sub-system). As illustrated, a mobile phone 617 (e.g., mobile device), such as a mobile phone 617 capable of capturing eye-tracking features data may be calibrated, according to the systems and methods described herein.

In various embodiments, the mobile phone 617 may be a smartphone or tablet device manufactured by a fourth sub-system that has accessed the software development package from the automated platform. The mobile phone 617 may include one or more front-facing cameras positioned on the device housing to capture eye-tracking features data from a user interacting with the device during activities such as reading, browsing, gaming, or participating in mobile health applications. The front-facing camera may capture data such as gaze position relative to the display, pupil diameter variations, blink rate, fixation patterns across different screen regions, or facial orientation at a sampling rate particular to the hardware specifications of the mobile phone 617. In some aspects, the automated conversion engine may be installed as part of a mobile application on the mobile phone 617 and may convert the captured eye-tracking data into a time series format suitable for processing by the calibrated assessment model. The calibrated assessment model may then analyze the eye-tracking features to determine a target assessment result, such as a user fatigue level during extended device use, an attention state during mobile learning activities, or a cognitive load indicator during task completion. In some cases, the mobile phone 617 may utilize the target assessment result to provide notifications to the user, such as recommending breaks during prolonged reading sessions, adjusting screen brightness or color temperature based on detected eye strain indicators, or generating wellness summaries for personal health tracking applications. In some implementations, the mobile phone 617 may be deployed in clinical research settings to enable remote data collection for studies involving cognitive assessments, or in consumer wellness applications to provide users with insights regarding their visual attention patterns and screen usage habits over time.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for integrating one or more assessment models using an automated platform, the method comprising:
receiving, by one or more processors, a request from a first sub-system for access to a software development package, wherein the request includes a unique identifier associated with the software development package, and wherein the software development package includes an automated conversion engine, a feature repository engine, and an assessment engine, each engine particular to the unique identifier;
verifying, by the one or more processors, the request using the unique identifier;
generating, by the one or more processors, a download including the software development package; and
transmitting, by the one or more processors, the download to the first sub-system.

2. The computer-implemented method of claim 1, wherein the automated conversion engine includes (i) one or more computer-readable instructions configured to be executed on a unique user device, and (ii) a first assessment model, wherein the first assessment model has been trained to determine a target assessment result using a set of eye-tracking data captured at a sampling rate.

3. The computer-implemented method of claim 2, wherein the automated conversion engine forms a calibrated assessment model specific to the unique user device.

4. The computer-implemented method of claim 1, wherein the software development package includes a repository of eye-tracking data.

5. The computer-implemented method of claim 1, further comprising training an assessment model of the automated conversion engine, the training comprising:
providing, by one or more processors of a computing system, one or more gathered or simulated sets of eye-tracking data stored in a repository of eye-tracking data to one or more target assessment algorithms as one or more sets of training data;
determining, by the one or more target assessment algorithms, associations between the one or more gathered or simulated sets of eye-tracking data and one or more target assessment results;
modifying one or more of a layer a weight, a synapse, or a node of the assessment model based on the associations between the one or more gathered or simulated sets of eye-tracking data and the one or more target assessment results; and
outputting, by the one or more processors, the assessment model, wherein the assessment model is trained to determine the target assessment result based on a set of eye-tracking data and output an assessment result based on the set of eye-tracking data and the modified one or more of the layer, the weight, the synapse, or the node of the assessment model.

6. The computer-implemented method of claim 1, wherein the download is transmitted via a web server in electronic communication with the first sub-system.

7. The computer-implemented method of claim 1, further comprising:
configuring, by the one or more processors, parameters for the automated conversion engine, the feature repository engine, and the assessment engine based on a set of requirements of the first sub-system.

8. A system for integrating one or more assessment models using an automated platform, the system comprising:
a data storage device storing instructions; and
one or more processors configured to execute the instructions to perform operations including:
receiving, by the one or more processors, a request from a first sub-system for access to a software development package, wherein the request includes a unique identifier associated with the software development package, and wherein the software development package includes an automated conversion engine, a feature repository engine, and an assessment engine, each engine particular to the unique identifier;
verifying, by the one or more processors, the request using the unique identifier;
generating, by the one or more processors, a download including the software development package; and
transmitting, by the one or more processors, the download to the first sub-system.

9. The system of claim 8, wherein the automated conversion engine includes (i) one or more computer-readable instructions configured to be executed on a unique user device, and (ii) a first assessment model, wherein the first assessment model has been trained to determine a target assessment result using a set of eye-tracking data captured at a sampling rate.

10. The system of claim 9, wherein the automated conversion engine forms a calibrated assessment model specific to the unique user device.

11. The system of claim 8, wherein the software development package includes a repository of eye-tracking data.

12. The system of claim 8, the operations further comprising training an assessment model of the automated conversion engine, the training comprising:
providing, by one or more processors of a computing system, one or more gathered or simulated sets of eye-tracking data stored in a repository of eye-tracking data to one or more target assessment algorithms as one or more sets of training data;
determining, by the one or more target assessment algorithms, associations between the one or more gathered or simulated sets of eye-tracking data and one or more target assessment results;
modifying one or more of a layer a weight, a synapse, or a node of the assessment model based on the associations between the one or more gathered or simulated sets of eye-tracking data and the one or more target assessment results; and
outputting, by the one or more processors, the assessment model, wherein the assessment model is trained to determine the target assessment result based on a set of eye-tracking data and output an assessment result based on the set of eye-tracking data and the modified one or more of the layer, the weight, the synapse, or the node of the assessment model.

13. The system of claim 8, wherein the download is transmitted via a web server in electronic communication with the first sub-system.

14. The system of claim 8, the operations further comprising:
configuring, by the one or more processors, parameters for the automated conversion engine, the feature repository engine, and the assessment engine based on a set of requirements of the first sub-system.

15. A non-transitory machine-readable medium storing instructions that, when executed by one or more processors, cause the one or more processors to perform a method for integrating one or more assessment models using an automated platform, the method comprising:
receiving, by the one or more processors, a request from a first sub-system for access to a software development package, wherein the request includes a unique identifier associated with the software development package, and wherein the software development package includes an automated conversion engine, a feature repository engine, and an assessment engine, each engine particular to the unique identifier;
verifying, by the one or more processors, the request using the unique identifier;
generating, by the one or more processors, a download including the software development package; and
transmitting, by the one or more processors, the download to the first sub-system.

16. The non-transitory machine-readable medium of claim 15, wherein the automated conversion engine includes (i) one or more computer-readable instructions configured to be executed on a unique user device, and (ii) a first assessment model, wherein the first assessment model has been trained to determine a target assessment result using a set of eye-tracking data captured at a sampling rate.

17. The non-transitory machine-readable medium of claim 16, wherein the automated conversion engine forms a calibrated assessment model specific to the unique user device.

18. The non-transitory machine-readable medium of claim 15, wherein the software development package includes a repository of eye-tracking data.

19. The non-transitory machine-readable medium of claim 15, the method further comprising training an assessment model of the automated conversion engine, the training comprising:
providing, by one or more processors of a computing system, one or more gathered or simulated sets of eye-tracking data stored in a repository of eye-tracking data to one or more target assessment algorithms as one or more sets of training data;
determining, by the one or more target assessment algorithms, associations between the one or more gathered or simulated sets of eye-tracking data and one or more target assessment results;
modifying one or more of a layer a weight, a synapse, or a node of the assessment model based on the associations between the one or more gathered or simulated sets of eye-tracking data and the one or more target assessment results; and
outputting, by the one or more processors, the assessment model, wherein the assessment model is trained to determine the target assessment result based on a set of eye-tracking data and output an assessment result based on the set of eye-tracking data and the modified one or more of the layer, the weight, the synapse, or the node of the assessment model.

20. The non-transitory machine-readable medium of claim 15, wherein the download is transmitted via a web server in electronic communication with the first sub-system.
